(19) United States
(12) Patent Application Publication
(10) Pub. No.: US 2025/0306964 A1
(43) Pub. Date: Oct. 2, 2025

(54) OUTPUT APPARATUS AND OUTPUT METHOD

(71) Applicant: Lenovo (Beijing) Limited, Beijing (CN)

(72) Inventors: Shuang HAN, Beijing (CN); Zhiyong LU, Beijing (CN); Xiaoxi CHEN, Beijing (CN)

(21) Appl. No.: 19/094,571

(22) Filed: Mar. 28, 2025

(30) Foreign Application Priority Data
Mar. 31, 2024 (CN) 202410384291.2

(51) Int. Cl. G06F 9/451; G06F 13/42

(52) U.S. Cl. CPC G06F 9/451; G06F 13/4282; G06F 2213/0042

(57) ABSTRACT

An output apparatus includes an interaction interface, first and second interface groups, a multifunctional interface, a first output device, and a processing device configured to control the output apparatus and another output apparatus connected to the multifunctional interface to synchronously switch from a first mode to a second mode. When the output apparatus is in the first mode, the first output device and a second output device of the other output apparatus can output media data from a first processing apparatus, and the first processing apparatus and an interaction apparatus can transmit interaction data. When the output apparatus is in the second mode, the first output device and the second output device can output media data from a second processing apparatus, and the second processing apparatus and the interaction apparatus can transmit interaction data.

### CROSS-REFERENCE TO RELATED APPLICATION

This application claims priority to Chinese Patent Application No. 202410384291.2, filed on Mar. 31, 2024, the entire content of which is incorporated herein by reference.

### TECHNICAL FIELD

The present disclosure generally relates to the field of information processing technologies and, more particularly, to an output apparatus and an output method.

### BACKGROUND

Interface types of output apparatuses such as monitors are becoming increasingly diverse. For example, output apparatuses not only have video interfaces that support video data transmission, but also USB interfaces that support USB apparatus interaction. With the continuous development of technology, there are generally multiple video interfaces and USB interfaces on an output apparatus. The output apparatus may be connected to other output apparatuses while also being connected to multiple other electronic apparatuses for providing multimedia data such as video data and for realizing data interaction such as interaction control. In this case, when it is needed to switch the electronic apparatuses that provide multimedia data such as video or USB-related data, there will be a problem of high apparatus switching complexity.

### SUMMARY

In accordance with the disclosure, there is provided an output apparatus including an interaction interface, a first interface group, a second interface group, a multifunctional interface, a first output device, and a processing device configured to control, through the multifunctional interface, the output apparatus and another output apparatus connected to the multifunctional interface to synchronously switch from a first mode to a second mode. When the output apparatus is in the first mode, the first output device is able to output first media data from a first processing apparatus connected to the first interface group, a second output device of the other output apparatus is able to output second media data from the first processing apparatus, and the first processing apparatus and an interaction apparatus connected to the interaction interface are able to transmit interaction data with each other. When the output apparatus is in the second mode, the first output device is able to output third media data from a second processing apparatus connected to the second interface group, the second output device is able to output fourth media data from the second processing apparatus, and the second processing apparatus and the interaction apparatus are able to transmit interaction data with each other.

Also in accordance with the disclosure, there is provided an output method including, when a first output apparatus is in a first mode, obtaining first media data from a first processing apparatus, outputting the first media data to a first output device, and controlling the first processing apparatus to transmit interaction data with an interaction apparatus connected to the first output apparatus, and, based on a multifunctional interface, of the first output apparatus, that is connected to a second output apparatus, controlling the first output apparatus and the second output apparatus to switch synchronously from the first mode to a second mode. The second output apparatus is configured to, when in the first mode, obtain second media data from the first processing apparatus and output the second media data to a second output device of the second output apparatus. The method further includes, when the first output apparatus is in the second mode, obtaining third media data from a second processing apparatus, outputting the third media data to the first output device, and controlling the second processing apparatus to transmit interaction data with the interaction apparatus. The second output apparatus is further configured to, when in the second mode, obtain fourth media data from the second processing apparatus and output the fourth media data to the second output device.

### BRIEF DESCRIPTION OF THE DRAWINGS

To more clearly illustrate the technical solutions of the embodiments of the present disclosure, the drawings needed for use in the description of the embodiments will be briefly introduced below. The drawings described below are some embodiments of the present disclosure. For those of ordinary skill in the art, other drawings can be obtained according to these drawings without any creative work.

FIG. 1 is a schematic structural diagram of an output apparatus consistent with embodiments of the present disclosure.

FIG. 2 is a schematic diagram showing an architecture of an application scenario consistent with embodiments of the present disclosure.

FIG. 3 is another schematic structural diagram of an output apparatus consistent with embodiments of the present disclosure.

FIG. 4 is a schematic diagram showing another architecture of an application scenario consistent with embodiments of the present disclosure.

FIG. 5 is a schematic diagram showing another architecture of an application scenario consistent with embodiments of the present disclosure.

FIG. 6 is a schematic diagram showing another architecture of an application scenario consistent with embodiments of the present disclosure.

FIG. 7 is a schematic diagram showing another architecture of an application scenario consistent with embodiments of the present disclosure.

FIG. 8 is a flowchart of an output method consistent with embodiments of the present disclosure.

FIG. 9 is a flowchart of another output method consistent with embodiments of the present disclosure.

### DETAILED DESCRIPTION OF THE EMBODIMENTS

Specific embodiments of the present disclosure are described hereinafter with reference to the accompanying drawings to describe the technical solutions in the embodiments of the present disclosure. The described embodiments are only part of the embodiments of the present disclosure, and not all of the embodiments. Based on the embodiments in the present disclosure, all other embodiments obtained by those skilled in the art without creative work are within the scope of protection of the present disclosure.

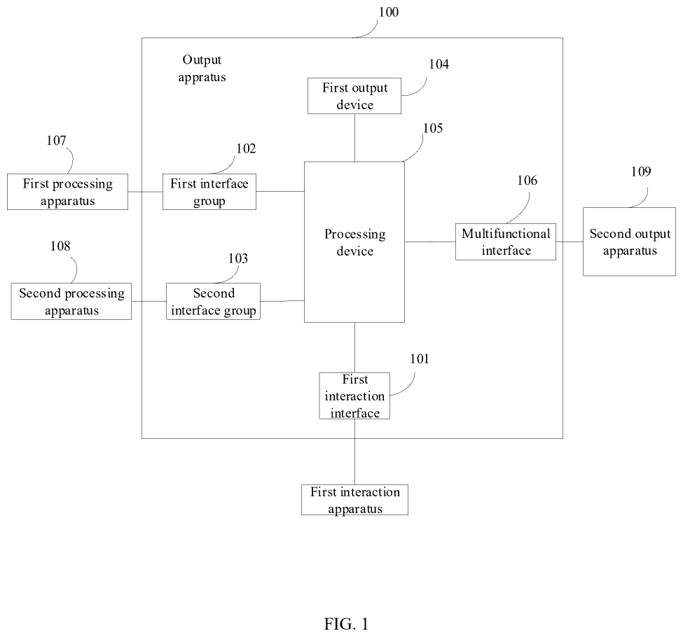

The present disclosure provides an output apparatus. FIG. 1 is a schematic structural diagram of an output apparatus consistent with various embodiments of the present disclosure.

As shown in FIG. 1, the output apparatus 100 includes at least one first interaction interface 101, a first interface group 102, a second interface group 103, a first output device 104, a processing device 105, and a multifunctional interface 106.

The at least one first interaction interface 101 may be used to be connected to a first interaction apparatus.

The at least one first interaction interface may be an interface provided at the output apparatus that may be connected to various interaction apparatuses. For example, the interaction interface may be a USB interface, or other types of interfaces compatible with USB interfaces, etc.

An interaction apparatus refers to an apparatus that is able to interact with the processing device connected to the output apparatus through the output apparatus, and the interaction data between the interaction apparatus and the processing device may include input instructions, input content or some data, etc. For example, the interaction apparatus may be an input apparatus, such as a keyboard and a mouse. As another example, the interaction apparatus may also be a data storage apparatus, for example, the interaction apparatus can be a mobile hard disk, or a Universal Serial Bus (USB) flash disk (commonly known as a U disk), etc.

In the present disclosure, for the sake of distinction, the interaction interface of the output apparatus is referred to as the first interaction interface, and the interaction interface of the subsequent second output apparatus is referred to as the second interaction interface. Correspondingly, the interaction apparatus connected to the first interaction interface is referred to as the first interaction apparatus, and the interaction apparatus connected to the second interaction interface is referred to as the second interaction apparatus.

The first interface group 102 may be used to be connected to the first processing apparatus 107.

The second interface group 103 may be used to be connected to the second processing apparatus 108.

In the present disclosure, for the sake of distinction, the two processing apparatuses connected to the output apparatus are respectively referred to as the first processing apparatus and the second processing apparatus. A processing apparatus may be a host, or an electronic apparatus such as a laptop, a desktop computer, or a mobile phone.

The first processing apparatus and the second processing apparatus may establish a connection with the output apparatus through at least one interface on the output apparatus. In the present disclosure, the interface group of the output apparatus used to be connected to the first processing apparatus is referred to as the first interface group, and the interface group connected to the second processing apparatus is referred to as the second interface group.

The first interface group and the second interface group may each include at least one interface.

The multifunctional interface 106 may be used to be connected to a second output apparatus 109. The second output apparatus may be an output apparatus other than the output apparatus, and is also referred to as an “additional output apparatus.” Correspondingly, the output apparatus to which the second output apparatus is connected can also be referred to as a “first output apparatus.” The multifunctional interface may support the transmission of interaction data and media data. For example, the multifunctional interface may be a Thunderbolt interface or a USB-C interface (also known as USB Type-C).

The first output device 104 may be used to output media data.

For example, the first output device may be a display screen, and the output apparatus may be an electronic apparatus including a display screen. For example, the output apparatus may be a smart TV, a smart display screen, or a desktop computer, etc. Therefore, the media data may include image data.

As another example, the first output device may be an audio output device, such as a speaker, etc., and the media data may include audio data.

Also, the first output device may include an image output device (such as a display screen) and an audio output device. Correspondingly, the media data may include at least image data to be displayed (such as a video, a picture, or a document, etc.), and may also include audio data.

The processing device 105 may be used to control the output apparatus and the second output apparatus to switch synchronously from a first mode to a second mode based on the multifunctional interface.

For example, the processing device may switch the first mode of the output apparatus to the second mode. At the same time, the processing device may send a mode switch signal to the second output apparatus through the multifunctional interface, and the mode switch signal may be used to instruct the second display apparatus to switch from the first mode to the second mode.

In the present disclosure, the output apparatus may be in different modes, and the media data output by the output apparatus may have different sources. That is, the processing apparatuses providing the media data sources may be different. Also, the processing apparatuses providing the media data of the output apparatus may be different, and the processing apparatuses controlled by the interaction apparatuses connected to the output apparatus may also be different.

In the present disclosure, the mode switch signal indicating switching to the second mode may indicate the signal source corresponding to the second mode (such as the processing apparatus or the interface group connected to the processing apparatus), such that the second output apparatus switches the signal source to the corresponding signal source.

When the output apparatus is in the first mode, the first output device may output the first media data from the first processing apparatus, the second output device of the second output apparatus may output the second media data from the first processing apparatus, and the first processing apparatus and the first interaction apparatus may transmit interaction data between each other.

When the output apparatus is in the second mode, the first output device may output the third media data from the second processing apparatus, the second output device may output the fourth media data from the second processing apparatus, and the second processing apparatus and the first interaction apparatus may transmit interaction data between each other.

In the present disclosure, when the output apparatus and the second output apparatus are in the same display mode, the media data displayed by each may be different, but the media data may all originate from the same processing apparatus.

For example, in the first mode, the first media data output by the first output device and the second media data output by the second output device may all originate from the first processing apparatus, where the first media data and the second media data may be the same or different. In actual application scenarios, the first media data and the second media data may be generally different. The second mode is similar and will not be described in detail.

In the present disclosure, for ease of distinction, the output device of the output apparatus is referred to as the first output device, and the output device in the second output apparatus is referred to as the second output device. It can be understood that the second output apparatus may be an apparatus of the same type or a different type as the output apparatus, and the second output device may have the same meaning as the first output device, which will not be described in detail.

In the present disclosure, when the output apparatus is connected to the second output apparatus via the multifunctional interface, the output apparatus may control the output apparatus and the second output apparatus to switch from the first mode to the second mode synchronously. Further, in the first mode, the first output device of the output apparatus and the second output device of the second output apparatus may both obtain and output the media data from the first processing apparatus, and the first processing apparatus and the first interaction apparatus connected to the output apparatus may transmit interaction data between each other. In the second mode, the output apparatus and the second output apparatus may both obtain and output the media data from the second processing apparatus, and the second processing apparatus and the first interaction apparatus may transmit interaction data between each other. Therefore, the present disclosure may be able to realize the synchronous switching of the output apparatus and the second output apparatus between the first mode and the second mode, which not only ensures that the two interconnected output apparatuses are able to synchronously output the media data from the same processing apparatus, but also are able to synchronously switch the interaction apparatus connected to the output apparatus to interact with the processing apparatus. Therefore, the user may be able to switch the media data source and the processing apparatus controlled by the interaction apparatus without the need for complex operations such as manually configuring the line connection relationship on the two output apparatuses respectively, and naturally it may be more efficient to switch the two output apparatuses and the interaction apparatus to the same processing apparatus for data transmission. The complexity of synchronously connecting multiple output apparatuses and interaction apparatuses to an electronic apparatus corresponding to a media data source may be reduced.

In the first mode, the first processing apparatus may not only output the media data to the output device of the output apparatus through the first interface group, but also transmit the interaction data with the first interaction apparatus connected to the output apparatus. Therefore, the first interface group may support the transmission of media data and interaction data.

Similarly, when the output apparatus is able to switch to the second mode, it may mean that the second interface group also supports the transmission of media data and interaction data.

In the present disclosure, the interfaces on the output apparatus for connecting the processing apparatus may be of multiple types.

For example, the output apparatus may include at least one integrated interface. One integrated interface may support the transmission of media data or interaction data. For example, the integrated interface may be a USB-C interface (also known as USB Type-C) or a Thunderbolt (TBT) interface. The Thunderbolt interface may be an integrated transmission interface that supports the fast transmission of data, audio, or video streams.

As another example, the output apparatus may further include at least one media interface (also known as a video interface) that supports the transmission of media data such as image data. For example, one media interface may be a High Definition Multimedia Interface (HDMI), or at least one of a DP (DisplayPort) interface, etc. DP is a digital video interface standard standardized by the Video Electronics Standards Association (VESA).

As another example, the output apparatus may also include at least one data interface supporting interaction data transmission, such as a USB interface.

Based on the various interface types of the output apparatus, in the present disclosure, there may be multiple possibilities for interfaces included in the first interface group and the second interface group.

For example, in one embodiment, the first interface group may include: a first data interface supporting interaction data transmission and a second media interface supporting media data transmission. For example, the first data interface may be a USB interface, and the second media interface may be an HDMI interface or a DP interface, etc.

In another embodiment, the first interface group may be a first integrated interface supporting interaction data and media data transmission. In this case, the first interface group may actually be an integrated interface that supports the transmission of interaction data and media data. For example, the first integrated interface may be compatible with the functions of the USB interface and the media interface. For example, the second interface group may be a USB-C interface, or a Thunderbolt interface.

In the present disclosure, since the output apparatus is connected to the second output apparatus via the multifunctional interface and the multifunctional interface supports not only media data transmission but also interaction data transmission, in the second mode, to enable the second output device of the second output apparatus to obtain and output the media data from the second processing apparatus, the second output apparatus may obtain the media data from the second processing apparatus from the output apparatus via the multifunctional interaction interface.

The second output apparatus may also be connected to the second processing apparatus at least through a media interface, such that the second output apparatus is able to directly obtain media data from the second processing apparatus through the media interface.

To enable the first interaction apparatus to interact with the second processing apparatus, in one embodiment, the second interface group may support interaction data transmission, such that the first interaction apparatus is connected to the second processing apparatus through the second interface group (such as the second data interface or the second integrated interface in the second interface group). In some other embodiments, the second output apparatus may be connected to the second processing apparatus through a third interface group that at least supports interaction data transmission, and, on this basis, the first interaction apparatus may interact with the second processing apparatus through the multifunctional interface and the third interface group.

In the present disclosure, the second interface group may have multiple possibilities, which are described below in several possible situations.

In one embodiment, the second interface group may be similar to the first interface group in composition. The second interface group may include a second data interface that supports interaction data transmission and a second media interface that supports media data transmission. Or, in another embodiment, the second interface group may include a second integrated interface that supports interaction data and media data transmission. For example, the second interface group may include: a USB interface that supports USB data transmission, and an HDMI interface or DP interface that supports media data transmission. As another example, the second interface group may be a Thunderbolt interface.

Based on this possible situation of the second interface group and the several possible situations of the first interface group mentioned above, there may be multiple possible combinations of the second interface group and the first interface group.

For example, the first interface group may include a first data interface and a first media interface, and the second interface group may include a second data interface and a second media interface. For example, both the first interface group and the second interface group may be Thunderbolt interfaces.

As another example, the first interface group may be a first integrated interface, and the second interface group may include a second data interface and a second Thunderbolt interface. For example, the first interface group may include a USB-C or Thunderbolt interface, and the second interface group may include an HDMI (or DP) interface and a USB interface.

As another example, the first interface group may include a first data interface and a first media interface, and the second interface group may be a second integrated interface. For example, the first interface group may include an HDMI (or DP) interface and a USB interface, and the second interface group may be a USB-C or Thunderbolt interface.

In the above several possible situations of the first interface group and the second interface group, when the output apparatus is in the first mode, the processing device of the output apparatus may be used to control the first media interface or the first integrated interface in the first interface group to communicate with the first output device, and control the first data interface or the first integrated interface of the first interface group to communicate with the at least one interaction interface, such that the first output device is able to obtain the first media data from the first processing apparatus connected to the first interface group and the first interaction apparatus is able to transmit interaction data with the first processing apparatus connected to the first interface group.

It can be understood that when the output apparatus is in the first mode, the output apparatus may control the second output apparatus to be in the first mode synchronously, and the second output apparatus may obtain the second media data from the first processing apparatus through the multifunctional interface via the output apparatus.

When the second output apparatus is connected to the first processing apparatus through a media interface or integrated interface that at least supports media data transmission, in the second mode, the second output apparatus may directly obtain the second media data from the first processing apparatus through the media interface or integrated interface.

Accordingly, when the output apparatus is in the second mode, the processing device may be used to control the second media interface or the second integrated interface in the second interface group to be connected to the first output device, and control the second data interface or the second integrated interface in the second interface group to be connected to the at least one interaction interface, such that the first output device is able to obtain media data from the second processing apparatus connected to the second interface group and the first interaction apparatus is able to transmit interaction data with the second processing apparatus.

The specific implementation of the output apparatus controlling the second output apparatus to switch to the second mode may be as described above, and accordingly, the process where the second output apparatus obtains the media data from the second processing apparatus and the second output apparatus obtains the media data from the first processing apparatus may be similar to the process of the second output apparatus obtaining the media data from the first processing apparatus, which will not be repeated.

For ease of understanding, in this possible case of the second interface group, the data interaction relationship between the output apparatus, the second output apparatus, the interaction apparatus, the first processing apparatus, and the second processing apparatus will be introduced in conjunction with an application scenario.

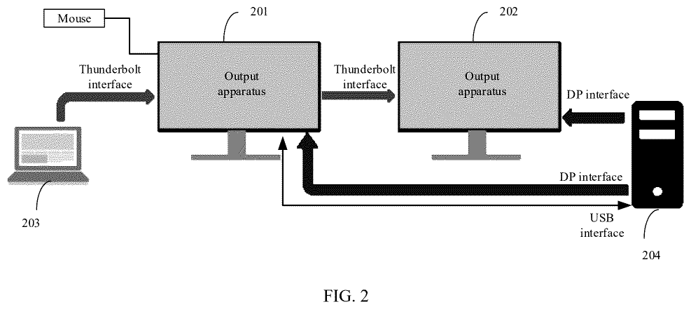

FIG. 2 is a schematic diagram showing the architecture of an application scenario applicable to the embodiments of the present disclosure.

Any output apparatus in FIG. 2 may be an electronic apparatus including a display unit (a display screen). For example, an output apparatus may be a monitor or a smart TV. Correspondingly, the output device of the output apparatus may include a display screen, a speaker, etc.

As shown in FIG. 2, the output apparatus 201 is connected to another output apparatus 202 via a Thunderbolt interface (TBT interface), and the Thunderbolt interface supports the transmission of interaction data and media data between the two output apparatuses. In FIG. 2, the description uses the output apparatus 201 transmitting the media data obtained by the output apparatus 201 from the media data source to the output apparatus 202 as an example, and the connection line corresponding to the Thunderbolt interface between the output apparatus 201 and the output apparatus 202 in FIG. 2 points from the output apparatus 201 to the output apparatus 202. It can be understood that the output apparatus 202 may also transmit interaction data and media data to the output apparatus 201 via the Thunderbolt interface.

The output apparatus 201 is connected to the laptop computer 203 via the Thunderbolt interface. In FIG. 2, the electronic apparatus connected to the output apparatus 201 via the Thunderbolt interface being a laptop computer is used as an example. The laptop computer 203 may also be replaced by other electronic apparatuses.

In FIG. 2, the laptop computer 203 supports the daisy chain function, such that the laptop computer 203, the output apparatus 201 and the output apparatus 202 are connected via a daisy chain. The daisy chain function is able to connect multiple monitors in series and connect them to a single interface. For example, in FIG. 2, one laptop computer and two output apparatuses are connected in series, and different media data from the laptop computer may be output on different output apparatuses.

The output apparatus 201 connected to the Thunderbolt interface of the laptop computer is equivalent to an interface group including an integrated interface.

Also, the output apparatus 201 is connected to the first host apparatus 204 through the DP interface. As shown in FIG. 2, the electronic apparatus connected to the output apparatus 201 through the DP interface being the host apparatus is used as an example. The first host apparatus may be replaced with other electronic apparatuses such as a mobile phone or a laptop computer.

Also, the output apparatus 201 is connected to the first host apparatus 204 through a USB interface.

For the output apparatus 201, the first host apparatus 204 is a processing apparatus, and the DP interface and USB interface of the output apparatus 201 used to be connected to the first host apparatus 204 constitute an interface group, where the DP interface is a media interface and the USB interface is a data interface.

The output apparatus 201 may also be connected to an interaction apparatus via an interaction interface. In FIG. 2, the output apparatus 201 connected to a mouse is used as an example. The mouse may be replaced with an interaction apparatus such as a keyboard or a USB flash drive, and the present disclosure is no limitation on this.

In one possible implementation, each interaction interface of the output apparatus may be integrated into a hub which is also called a multi-port repeater. The hub may provide multiple USB interfaces for connecting a keyboard or a mouse.

The output apparatus 202 may also be connected to the first host apparatus 204 through the DP interface.

In the architecture of FIG. 2 and subsequent application scenarios, the output apparatus 201 as an output apparatus for controlling mode switching is used as an example for description purposes, and the output apparatus 202 may be equivalent to the second output apparatus connected to the output apparatus 201.

In FIG. 2 and subsequent application scenarios, it is assumed that in the first mode, the output apparatus 201 and the output apparatus 202 use the Thunderbolt interface as an example of a media data source for providing media data.

When the output apparatus 201 is in the first mode, the output apparatus 201 controls the Thunderbolt interface connected to the laptop computer 203 to communicate with the output device of the output apparatus 201 (equivalent to the first output device), such that the output apparatus 201 is able to obtain the media data from the laptop computer 203 through the Thunderbolt interface and output it to its output device.

In the present disclosure, under the premise that the output apparatus 201 and the output apparatus 202 are connected through a multifunctional interface (a thunderbolt interface in FIG. 2), the output apparatus 201 and the output apparatus 202 may be able to maintain mode synchronization. For example, when the output apparatus 201 switches to the first mode, the output apparatus 202 may be notified to switch to the first mode through the thunderbolt interface; or when the output apparatus 202 switches to the first mode, the output apparatus 201 may be notified to switch to the first mode through the thunderbolt interface.

Correspondingly, when the output apparatus 202 is in the first mode, since the output apparatus 201 and the output apparatus 202 and the laptop computer 203 are connected in series through the thunderbolt interface, that is, they are connected in series in the form of a daisy chain, the output apparatus 202 may also control its thunderbolt interface to be connected to its output device, to obtain media data from the laptop computer 203 through its thunderbolt interface and output it to the output device (equivalent to the second output device).

The output apparatus 202 may obtain the media data from the laptop computer 203 transmitted by the output apparatus 201 through the thunderbolt interface. For example, the output apparatus 201 may obtain two media data from the laptop computer 203 through the Thunderbolt interface connected to the laptop computer 203, which are respectively called media data A and media data B. The output apparatus 201 may output the media data A to the output device of the output apparatus 201, and transmit the media data B to the output apparatus 202 through the Thunderbolt interface connected to the output apparatus 202. Correspondingly, the output apparatus 202 outputs the media data B obtained through the Thunderbolt interface to its output device.

In the first mode, to enable the mouse connected to the output apparatus 201 to control the media data source currently providing media data, that is, the laptop computer 203, the output apparatus 201 may control the interaction interface connected to the mouse to be connected to the Thunderbolt interface connected to the laptop computer, such that interaction data is able to be transmitted between the mouse and the laptop computer.

When the output apparatus 201 confirms that it needs to switch to the second mode, the output apparatus 201 may send a mode switching signal for indicating switching to the second mode to the output apparatus 202 through the Thunderbolt interface connected to the output apparatus 202. Correspondingly, the output apparatus 202 may switch the output apparatus 202 from the first mode to the second mode in response to the mode switching signal.

In the second mode, the output apparatus 201 may control the DP interface to be connected to its output device, obtain media data from the first host apparatus 204 through the DP interface, and output it to its output device. The same is true for the output apparatus 202. The output apparatus 202 may obtain the media data of the first host apparatus 204 through the DP interface and output it to its output device. The media data obtained by the output apparatus 201 and the media data obtained by the output apparatus 202 from the first host apparatus 204 may be different.

Further, in the second mode, since the USB interface of the output apparatus 201 is also connected to the first host apparatus and the USB interface only supports interaction data transmission, to enable the mouse connected to the output apparatus 201 to switch from being connected to the laptop to being connected to the first host apparatus 204, the output apparatus 201 may control the interaction interface connected to the mouse to be connected to the USB interface, such that the mouse is able to control the first host apparatus and perform interaction data transmission with the first host apparatus.

Usually, when it is needed to switch the video source of the output apparatus and switch the processing apparatus connected to the keyboard or mouse, the user needs to manually operate on the two output apparatuses to switch the video source, and also needs to manually switch the processing apparatus connected to the mouse or keyboard, which is relatively complex.

In the present disclosure, with the help of signal source synchronization between the two output apparatuses, when an output apparatus switches from the first mode to the second mode, the other output apparatus may also be controlled to switch to the second mode synchronously, and the keyboard and mouse connected to the output apparatus may be automatically switched to the second processing apparatus corresponding to the second mode. Therefore, one mode switch may achieve synchronous switching of media data sources such as video of the two output apparatuses and switching of USB apparatuses connected to interaction apparatuses such as mice.

In the first mode and the second mode shown in FIG. 2, the first interface group (the interface group connected to the laptop computer) is a Thunderbolt interface that supports both media data and interaction data transmission, and the second interface group (the interface group connected to the first host apparatus) includes a DP interface that supports media data transmission and a USB interface that supports interaction data transmission, which is used as an example for description purposes. In actual applications, the first interface group may also be replaced by a combination of a USB interface and a DP interface, or a combination of a USB interface and an HDMI interface; and the second interface group may also be a Thunderbolt interface, or a USB and an HDMI interface, which will not be described in detail.

FIG. 2 is an example of the first mode and the second mode, for description purposes only. In actual applications, in the first mode, the first host apparatus connected by the DP interface of the output apparatus may be used as the media data source. In the second mode, the media data sources of the two output apparatuses may be switched to the laptop computer 203 connected to the Thunderbolt interface. Correspondingly, the output apparatus 201 may also connect the interaction interface connected to the mouse with the DP interface, and switch the mouse interface to the Thunderbolt interface connected to the laptop computer. The specific process is similar and will not be described in detail.

The above embodiments where the second interface group supports both media data transmission and interaction data transmission are used as examples for description. In this case, when the output apparatus switches to the second mode, the first interaction interface on the output apparatus may be connected to the second data interface or the second integrated interface in the second interface group, such that the first interaction apparatus is able to perform interaction data transmission with the second processing apparatus connected to the second interface group. Further, in this case, it may not be necessary to consider whether the second output apparatus and the second processing apparatus are connected through a data interface that supports interaction data transmission.

In another possible case, the second interface group may not support interaction data transmission, that is, the second interface group may only include a second media interface that supports media data transmission.

In this case, to enable the first interaction apparatus such as the mouse and keyboard connected to the output apparatus to control the second processing apparatus connected to the second interface group, the data interface that supports interaction data transmission in the second output apparatus may need to be connected to the second processing apparatus.

For example, the second output apparatus may include a third interface group for connecting to the second processing apparatus, where the third interface group may include: a third data interface supporting interaction data transmission and a third media interface supporting media data transmission.

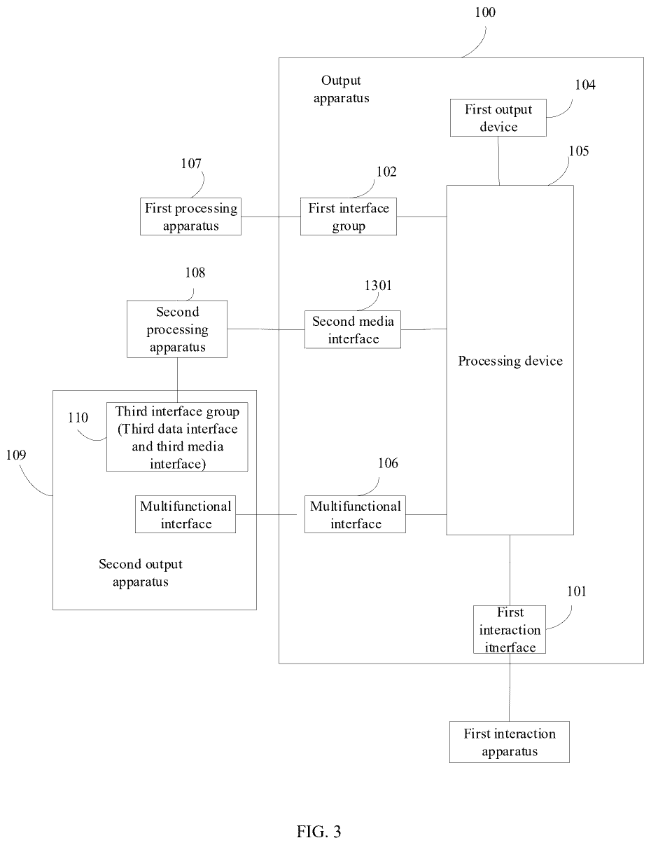

FIG. 3 is another schematic structural diagram of the output apparatus consistent with the embodiments of the present disclosure.

Comparing FIG. 1 and FIG. 3, it can be seen that the difference is that in FIG. 3, the second interface group of the output apparatus 100 is essentially a second media interface 1301, such that the second interface group only supports media data transmission, but cannot support the transmission of interaction data between interaction apparatuses such as a mouse and a keyboard.

Further, as shown in FIG. 3, the second processing apparatus to which the output apparatus is connected through the second media interface 1301 is also connected to the third interface group 110 of the second output apparatus 109. The third interface group includes: a third media interface supporting media data transmission, and a third data interface supporting interaction data transmission.

The second output apparatus may also include a processing device and other interface groups, which are similar to the output apparatus and will not be repeated here. Further, in combination with the description of FIG. 1 and FIG. 2, it can be known that the second output apparatus 109 may be directly connected to the first processing apparatus through its interface group; or the second output apparatus 109 may not be directly connected to the first processing apparatus and may be connected in series with the output apparatus 100 and the first processing apparatus through a multifunctional interface, and there is no limitation on this.

Based on FIG. 3, the processing device 105 of the output apparatus 100 may also be used to determine that the third interface group includes the third data interface through the multifunctional interface of the output apparatus 100.

For example, when the second output apparatus 109 confirms that its third interface group is connected to the second processing apparatus, it may send the interface connection information of the third interface group to the output apparatus 100 through the multifunctional interface 106. The interface connection information may indicate which types of interfaces connected to the processing apparatus are included. Therefore, it may be determined whether the third interface group connected to the third processing apparatus includes the third data interface through the interface group connection information.

As another example, when the output apparatus 100 confirms that the first mode needs to be switched to the second mode, and before switching to the second mode, the output apparatus 100 may request the interface connection information of the third interface group for connecting the second processing apparatus from the second output apparatus 109 through the multifunctional interface 106.

When the output apparatus 100 is in the second mode, the processing apparatus 105 may be used to control the second media interface 1301 to be connected to the first output device 104, and control the at least one first interaction interface 101 to be connected to the multifunctional interface 106.

When the second media interface is connected to the first output device, the first output device may output the third media data from the second processing apparatus connected to the second media interface. Correspondingly, since the second output apparatus will also switch to the second mode synchronously, the second output apparatus may also connect the third media interface in its third interface group to the second output apparatus, such that the second output apparatus may also obtain the fourth media data from the second processing apparatus.

The output apparatus 100 may connect at least one first interaction interface 101 and the multifunctional interface 106, such that the first interaction apparatus connected to the first interaction interface 101 may transmit interaction data between the second processing apparatus through the multifunctional interface 106 and the third data interface in the third interface group 110. Therefore, the first interaction apparatus such as a mouse, a USB flash drive or a keyboard may transmit interaction data with the second processing apparatus.

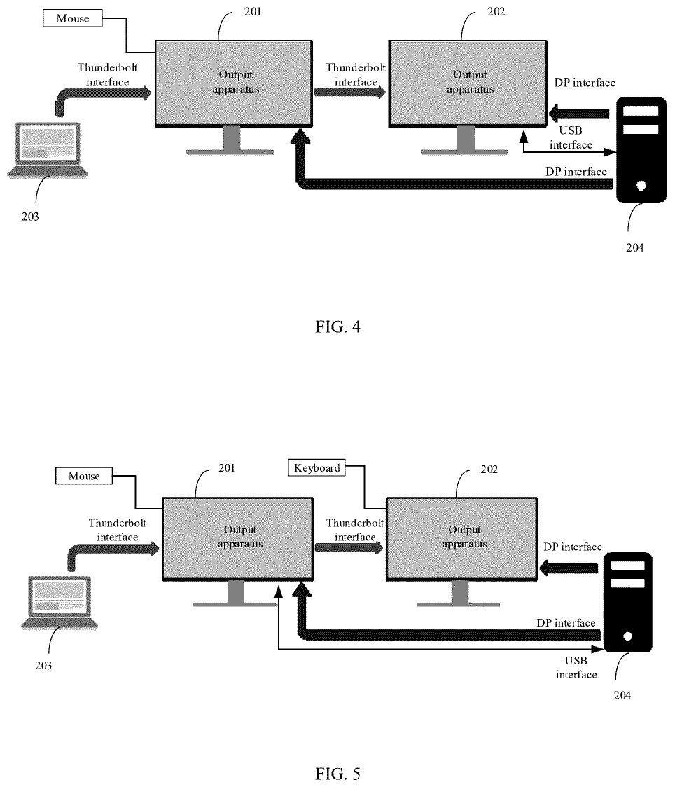

For ease of understanding, an application scenario shown in FIG. 4 will be used as an example for description in the following.

In FIG. 2, the USB interface and the DP interface of the output apparatus 201 are connected to the first host apparatus 204, and only the DP interface of the output apparatus 202 is connected to the first host apparatus 204. In FIG. 4, only the DP interface (relative to the second media interface) of the output apparatus 201 is connected to the first host apparatus 204, while the DP interface (equivalent to the third media interface) and the USB interface (equivalent to the third data interface) of the output apparatus 202 are both connected to the first host apparatus 204.

From the perspective of the output apparatus 201, the output apparatus 202 is regarded as the second output apparatus connected to the output apparatus 201 through the multifunctional interface (i.e., the Thunderbolt interface). In the first mode, both the output apparatus 201 and the output apparatus 202 obtain media data from the laptop computer 203 through the Thunderbolt interface, and the output apparatus 201 controls the interaction interface (such as the USB interface) connected to the mouse to be connected to the Thunderbolt interface connected to the laptop computer 203.

In the second mode, it is needed to control the media data to come from the first host apparatus 204. On this basis, in FIG. 4, the output apparatus 201 connects its output device to the DP interface for connecting to the first host apparatus 204. Under the control of the output apparatus 201, the output apparatus 202 also connects its output device to the DP interface for connecting to the first host apparatus 204.

In FIG. 4, there is no USB interface connection between the output apparatus 201 and the first host apparatus 204. Therefore, it is impossible to connect the interaction interface for connecting the mouse with the DP interface for connecting the first host apparatus 204 of the output apparatus 201.

Since the output apparatus 202 will inevitably connect the USB interface for connecting the first host apparatus 204 with the Thunderbolt interface for connecting the output apparatus 201 in the second mode, when the output apparatus 201 confirms that the output apparatus 202 is connected to the first host apparatus 204 through the USB interface, the output apparatus 201 only needs to control the interaction interface for connecting the mouse to the Thunderbolt interface for connecting the output apparatus 202 in the second mode, then the mouse may be connected to the first host apparatus 204 through the interaction interface, the Thunderbolt interface for connecting the output apparatus 202 and the USB interface of the output apparatus 202 for connecting the first host apparatus 204, such that the mouse is able to transmit interaction data to the first host apparatus.

It is understandable that in actual applications, because of the limited number of interaction interfaces on the output apparatus or the different connection relationships between the output apparatus and the interaction apparatus configured by the user in the actual application scenario, an interaction apparatus may also be connected to the interaction interface of the second output apparatus.

Correspondingly, the second output apparatus may include at least one second interaction interface, and the at least one second interaction interface may be used to be connected to the second interaction apparatus.

When the output apparatus is in the first mode, the first processing apparatus may also transmit interaction data with the second interaction apparatus through the multifunctional interface. When the output apparatus is in the second mode, the second processing apparatus may also transmit interaction data with the second interaction apparatus connected to the second output apparatus through the multifunctional interface of the output apparatus.

For example, in one embodiment, the first interface group may include: a first data interface supporting interaction data transmission and a first media interface supporting media data transmission; or, a first integrated interface supporting interaction data and media data transmission. The second interface group may include: a second data interface supporting interaction data transmission and a second media interface supporting media data transmission; or, a second integrated interface supporting interaction data and media data transmission.

Correspondingly, when the output apparatus is in the first mode, the processing device of the output apparatus may be used to control the first media interface or the first integrated interface in the first interface group to be connected to the first output device. And, at the same time, the first data interface or the first integrated interface of the first interface group may be controlled to be connected to the at least one first interaction interface and the multifunctional interface of the output apparatus, such that the first interaction apparatus is able to transmit interaction data with the first processing apparatus through the first interaction interface, and the second interaction apparatus is able to transmit interaction data with the first processing apparatus through the second interaction interface and the multifunctional interface.

When the output apparatus is in the second mode, the processing device of the output apparatus may be used to control the second media interface or the second integrated interface in the second interface group to be connected to the first output device; and, at the same time, control the second data interface or the second integrated interface in the second interface group to be connected to the at least one first interaction interface and a multifunctional interface, such that the first interaction apparatus is able to transmit interaction data between the first interaction interface and the second processing apparatus, and the second interaction apparatus is able to transmit interaction data between the second interaction interface and the multifunctional interface and the second processing apparatus.

For ease of understanding, the application scenario shown in FIG. 5 will be used as an example for description in the following.

Compared to FIG. 2, in FIG. 5, a keyboard is also connected to the interaction interface (such as a USB interface) of the output apparatus 202. FIG. 5 takes the interaction apparatus connected to the output apparatus 202 as a keyboard as an example, and the keyboard may also be replaced by other interaction apparatuses such as a mouse or a U disk, without limitation.

For the connection relationship between the apparatuses except the keyboard in FIG. 5, reference can be made to the relevant description of FIG. 2, which will not be repeated here.

For description, the first mode assumed in the relevant description of FIG. 2 is still taken as an example. In FIG. 5, it is assumed that the laptop computer 203 connected to the Thunderbolt interface in the first mode is used as the media data source.

Therefore, in the first mode, the output apparatus 201 and the output apparatus 202 obtain the media data from the laptop computer 203. For details, references may be made to the relevant description of FIG. 2, and no further description is given.

In FIG. 5, since only the Thunderbolt interface of the output apparatus 201 is connected to the laptop computer 203 and the Thunderbolt interface supports the transmission of interaction data, in the first mode, the output apparatus 201 may connect the interaction interface for connecting the mouse with the Thunderbolt interface for connecting the laptop computer 203, such that the mouse is able to control the laptop computer.

The same is true for output apparatus 202. In the first mode, the output apparatus 202 connects the interaction interface for connecting the keyboard with the Thunderbolt interface for connecting the output apparatus 201. Since the Thunderbolt interface for connecting the output apparatus 202 of the output apparatus 201 is connected in series with the Thunderbolt interface for connecting the laptop computer 203, the interaction interface for connecting the keyboard of the output apparatus 202 is realized. By connecting the Thunderbolt interface of the output apparatus 201 and the Thunderbolt interface for connecting the laptop computer 203, the keyboard connected to the output apparatus 202 may also input information to the laptop computer or transmit other interaction information.

In the second mode, both the output apparatus 201 and the output apparatus 202 control their respective DP interfaces to be connected to their respective output devices, such that media data from the first host apparatus 204 may be obtained through their respective DP interfaces, as shown in FIG. 2, which will not be described in detail.

At the same time, in the second mode, the output apparatus 201 controls the interaction interface for connecting the mouse to be connected to the USB interface for connecting the first host apparatus 204, such that the mouse is able to interact with the first host apparatus 204 connected to the USB interface. Further, the output apparatus 201 is also able to obtain the interface connection information of the third interface group used by the output apparatus 202 to connect to the first host apparatus 204, and confirm through the interface connection information that there is no data interface connection between the output apparatus 202 and the first host apparatus 204. Therefore, the output apparatus 201 also controls the Thunderbolt interface connected to the output apparatus 202 to be connected to the USB interface for connecting the first host apparatus 204.

Since the output apparatus 202 in the second mode also controls the interaction interface connected to the keyboard to be connected to the Thunderbolt interface of the output apparatus 202 for connecting to the output apparatus 201, the keyboard may be connected to the USB interface of the output apparatus 201 for connecting to the first host apparatus 204 through the Thunderbolt interface between the output apparatus 201 and the output apparatus 202, such that the keyboard is also able to transmit interaction data with the first host device 204.

It can be understood that, when the second interaction interface of the second output apparatus is connected to the second interaction apparatus and the third interface group connected to the second processing device in the second output apparatus includes a third media interface and a third data interface, but the second interface group of the output apparatus only includes the second media interface, in the second mode, the second output apparatus may control the second interaction interface to be connected to the third data interface, such that the second interaction apparatus is able to transmit interaction data with the second processing apparatus. Further, to ensure that the first interaction apparatus is also able to be connected to the second processing apparatus, the second output apparatus may control the third data interface to be connected to the multifunctional interface for connecting the output apparatus.

For the output apparatus, the processing device of the output apparatus may control at least one first interaction interface and a multifunctional interface for connecting the second output apparatus to be connected, such that the first interaction apparatus is able to transmit interaction data with the second processing apparatus through the multifunctional interface and the third data interface. For details, references may be made to the relevant description of the case where the second interface group only includes the second media interface, which will not be repeated here.

In the above embodiments of the present disclosure, the processing device of the output apparatus may control the switching from the first mode to the second mode, which may be executed after confirming that the condition of switching from the first mode to the second mode is met.

There are multiple possibilities for the processing device to confirm whether the condition of switching from the first mode to the second mode is currently met.

In one possible embodiment, a mode switching instruction input by the user may be detected, and the mode switching instruction may be used to indicate switching to the second mode.

For example, the processing device of the output apparatus may obtain the mode switching instruction based on the mode switching operation of the user in the menu image. The mode switching instruction may be used to indicate switching from the first mode to the second mode, such that the output apparatus confirms that the condition of switching from the first mode to the second mode is met.

In the present disclosure, the menu image may be an on-screen display (OSD) image, which may be generated by the output apparatus, and the relevant options or function operation items in the menu image may be determined based on the connection status of the output apparatus, the processing device and the mode in which it is located. The display priority of the OSD image may be higher than the display priority of the image signal.

The user may trigger the output apparatus to display the menu image by touching the menu button of the output apparatus. In the menu image, the modes available for selection may be displayed, and different modes may represent different sources of media data.

For example, considering that different types of interfaces are required to obtain media data in different modes, different modes may be represented by different interface types, such as: mode 1: Thunderbolt interface; mode 2: DP interface, and mode 3: HDMI interface. The output apparatus may display the modes corresponding to the interfaces available for selection according to the connection of its interfaces to the processing apparatus, such that the user is able to choose.

Further, when the processing apparatus is connected to the output apparatus through a media interface, the menu image may also display whether the media interface is bound to a data interface such as a USB interface. For example, in FIG. 2, the output apparatus is connected to the first host apparatus 204 through a DP interface and a USB interface. Therefore, the mode 2 corresponding to the DP interface may be represented as: Mode 2: DP interface, USB interface.

In another possible embodiment, the output apparatus may also enable a signal source automatic switching function. When the output device detects that the media data source corresponding to the current mode is abnormal, it may automatically switch to other media data sources that are able to provide media data. The abnormal media data source may mean that the media data from the corresponding processing apparatus in the current mode cannot be obtained, such as a processing apparatus failure or sleep.

The signal source automatic switching function may be enabled by default, such as, when the display apparatus enables the signal source synchronization function, the signal source automatic switching function may be enabled by default. As another example, the signal source automatic switching function may also be enabled manually by the user performing the enable operation of the signal source automatic switching function in the menu image, which is similar to enabling the signal source synchronization function and will not be described in detail.

In this implementation, the output apparatus may determine that the condition for switching the first mode to the second mode is met when it detects that the first media data from the first processing apparatus cannot be obtained and that the output apparatus is able to obtain the media data from the second processing apparatus.

The above are examples of the conditions for switching from the first mode to the second mode. In actual applications, there may be other ways to confirm the need to switch to the second display mode, which is not limited.

It can be understood that above embodiments where the output apparatus is only connected to two processing apparatuses are used as examples for description purposes. In actual applications, the output apparatus may also be connected to multiple processing apparatuses.

For example, in one embodiment, the output apparatus may also include: an independent media interface for connecting to a third processing apparatus. The independent media interface may only support media data transmission.

Correspondingly, the processing device of the output apparatus may also be used to control the output apparatus and the second output apparatus to switch from the first mode to the third mode synchronously based on the multifunctional interface, or from the third mode to the first mode.

When the output apparatus is in the third mode, the first output device may output the fifth media data from the third processing apparatus, the second output device may output the sixth media data from the third processing apparatus, and the first processing apparatus and the first interaction apparatus may transmit interaction data.

Since the independent media interface only supports media data transmission and cannot support interaction data transmission between the first interaction apparatus and the third processing apparatus, when the output apparatus is connected to the third processing apparatus only through the independent media interface, if the media data source is switched from the first processing apparatus to the third processing apparatus, the first interaction apparatus may still transmit interaction data with the first processing apparatus.

For example, in the third mode, the processing device of the output apparatus may control the independent media interface to be connected to the first output device of the output apparatus, such that the first output device is able to obtain the fifth media data from the third processing apparatus through the independent media interface.

The second output apparatus and the third processing apparatus may be directly connected or connected through the output apparatus. Therefore, in the third mode, the second output apparatus may directly obtain the sixth media data from the third processing apparatus; or the output apparatus may obtain the fifth media data and the sixth media data from the third processing apparatus and transmit the sixth media data to the second output apparatus through the multifunctional interface. The specific process is similar to the above process of the second output apparatus obtaining the second media data and the fourth media data, which will not be repeated.

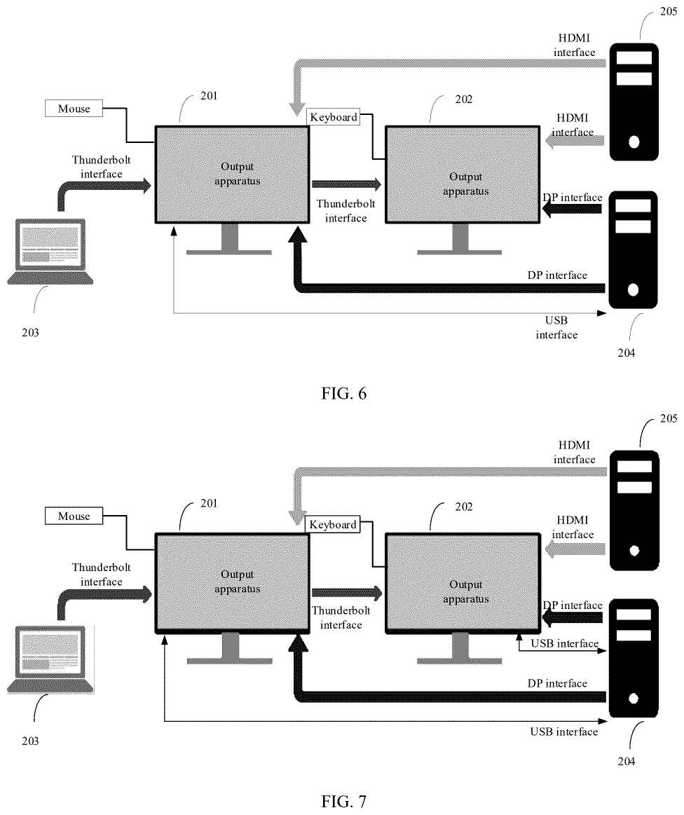

For ease of understanding, one embodiment where the second output apparatus and the third processing apparatus are connected only through the media interface will be used as an example, as shown in the application scenario shown in FIG. 6.

The application scenario in FIG. 6 is equivalent to the application scenario in FIG. 2, in which an additional processing apparatus is connected to the output apparatus 201 and the output apparatus 202.

For the connection relationship between the output apparatus 201, the output apparatus 202, the first processing apparatus, the second processing apparatus, and the mouse, references may be made to the relevant description of FIG. 2, which will not be repeated here.

As shown in FIG. 6, the output apparatus 201 is also connected to the second host apparatus 205 through the HDMI interface, where the HDMI interface is equivalent to a media interface that only supports media data transmission but does not support interaction data transmission using the USB protocol or other interaction data protocols.

Similarly, the output apparatus 202 is also connected to the second host apparatus 205 through the HDMI interface.

In FIG. 6, the first mode still takes the laptop computer 203 connected by the Thunderbolt interface as an example of a media data source. For the relevant operations of the output apparatus 201 and the output apparatus 202 in the first mode, references may be made to the relevant description of FIG. 2, FIG. 4 and FIG. 5, which will not be repeated here.

After confirming that it is needed to switch to the third mode, the output apparatus 201 may also send a mode switching signal to the output apparatus 202 through the Thunderbolt interface, which may be called the second mode switching signal for the sake of distinction. The second mode switching signal may be used to instruct the output apparatus 202 to switch from the first mode to the third mode.

The implementation of the output apparatus 201 confirming that it is needed to switch to the third mode may be similar to the implementation of the previous confirmation that it is needed to switch to the second mode. For example, the user may choose to switch to the HDMI interface as the media data source through the OSD menu to trigger the generation of the instruction to switch to the third mode, etc., which will not be described in detail.

Since both the output apparatus 201 and the output apparatus 202 are connected to the second host apparatus 205 only through the HDMI interface, the output apparatus 201 cannot switch the mouse to connect to the second host apparatus through the relevant implementation of the previous embodiments.

Therefore, in the third mode, the output apparatus 201 may control the HDMI interface to connect to the output device of the output apparatus 201, such that the output device is able to obtain the fifth media data provided by the second host apparatus 205 through the HDMI interface. At the same time, the output apparatus 201 may maintain the connection between the interaction interface for connecting the mouse and the Thunderbolt interface for connecting the laptop computer 203, without switching the interaction interface.

Similar to the output apparatus 202, in the third mode, the output apparatus may only need to control its HDMI interface to be connected to the output device of the output apparatus 202.

The above description is based on the case where the second output apparatus (such as the output apparatus 202) is not connected to the second interaction apparatus. When the second output apparatus is connected to the second interaction apparatus (such as a keyboard), when the second output apparatus switches to the third mode, the second output apparatus may still maintain the connection relationship of the second interaction interface in the first mode, that is, maintain the connection between the second interaction interface and the multifunctional interface of the output apparatus.

Further, the connection relationship between the two output apparatuses and the second host apparatus 205 in FIG. 6 is only used as an example, and the above description is also applicable to the case where the USB interface of the output apparatus 201 is not connected to the second host apparatus 205 but the output apparatus 202 is connected to the second processing apparatus 205 through the USB interface. For details, references may be made to the relevant description about the second mode in FIG. 4 above, which will not be repeated here.

It can be understood that, in the case where the output apparatus is connected to the third processing device through the independent media interface, the above embodiments are described by taking the absence of a data interface between the second output apparatus and the third processing apparatus as an example. In practical applications, the second output apparatus may also include a fourth data interface for connecting to the third processing apparatus.

For example, the second output apparatus may include: a fourth media interface and a fourth data interface, both of which are connected to the third processing apparatus. The fourth media interface may support media data transmission, and the fourth data interface may support interaction data transmission.

As another example, the second output apparatus may be connected to the third processing apparatus only through the fourth data interface, and the second output apparatus may output the obtained media data from the third processing apparatus through the multifunctional interface with the output apparatus.

On the premise that the second output apparatus is connected to the third processing apparatus through the fourth data interface, the processing device of the output apparatus may also be used to control the output apparatus to switch from the first mode to the fourth mode synchronously with the second output apparatus, or from the fourth mode to the first mode based on the multifunctional interface of the output apparatus.

The specific implementation of the processing device of the output apparatus determining the need to switch from the first mode to the fourth mode may also be similar to the implementation of switching between other modes, which will not be repeated here.

When the output apparatus is in the fourth mode, the first output apparatus may output the fifth media data from the third processing apparatus, the second output apparatus may output the sixth media data from the third processing apparatus, and the first interaction apparatus may transmit interaction data with the third processing apparatus through the multifunctional interface and the fourth data interface.

For example, the processing device of the output apparatus may be used to control at least one first interaction interface for connecting the first interaction apparatus to be connected to the multifunctional interface. Similar to the scenario in FIG. 4 above, the second output apparatus may also control the fourth data interface to be connected to the multifunctional interface, thereby realizing that at least one first interaction interface is connected to the fourth data interface through the multifunctional interface, and naturally realizing the connection between the first interaction apparatus and the fourth data interface. References may be made to the relevant scenario in FIG. 4 above for details, which will not be repeated here.

It can be understood that the above embodiments where one of the output apparatus and the second output apparatus may be connected to the second processing apparatus through a data interface are used as examples for description purposes only. In actual applications, when the second interface group of the output apparatus connected to the second processing apparatus is the second integrated interface or the second interface group includes the second media interface and the second data interface, the third interface group of the output apparatus for connecting the second processing device may also include the third data interface.

In this case, when the output apparatus is in the second mode, the processing device of the output apparatus may proceed according to the previous second interface group including the second integrated interface or the second interface group including the second media interface and the second data interface. That is, in the second mode, the output apparatus may control the second integrated interface or the second media interface in the second interface group to be connected to the first output device, and control the second integrated interface or the second data interface in the second interface group to be connected to at least one first interaction interface.

For example, when at least one second interaction interface of the second output apparatus is connected to the second interaction apparatus, in the second mode, the output apparatus may not need to control the second integrated interface or the second data interface in the second interface group to be connected to its multifunctional interface.

For the second output apparatus, since its third interface group includes a third data interface, in the second mode, the second output apparatus may only need to control the third data interface to be connected to at least one of its second interaction interfaces, such that the second interaction apparatus connected to it is able to transmit interaction data with the second processing apparatus.

For ease of understanding, please refer to FIG. 7.

Comparing the connection relationship between the output apparatus 201, the output apparatus 202 and the first host apparatus 204 in FIG. 2 (or FIG. 6), FIG. 4, and FIG. 7, it can be seen that in FIG. 7, both the output apparatus 201 and the output apparatus 202 have USB interfaces connected to the first host apparatus 204. Further, the interaction interface of the output apparatus 201 in FIG. 7 is connected to a mouse, and the interaction interface of the output apparatus 202 is connected to a keyboard.

In FIG. 7, the output apparatus 201 is in the second mode. In addition to controlling the DP interface to be connected to its output device, the output apparatus 201 may also control its interaction interface connected to the mouse to be connected to the USB interface connected to the first host apparatus 204, such that the mouse is able to interact with the first host device.

Similarly, when the output apparatus 202 is in the second mode, in addition to controlling the DP interface to connect to its output device, the output apparatus 202 may also control its interaction interface connected to the keyboard to be connected to the USB interface connected to the first host apparatus 204, thereby enabling the keyboard to interact with the first host apparatus.

The present disclosure also provides an output method.

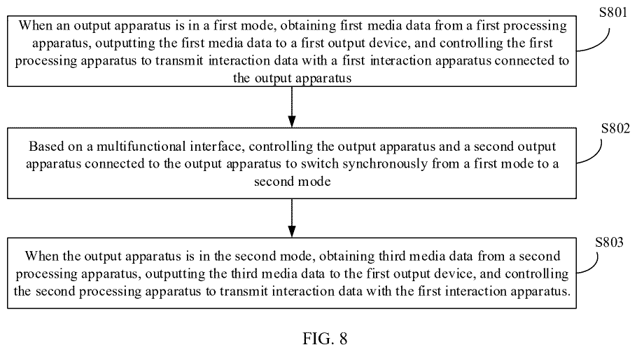

As shown in FIG. 8, which is a flowchart of the output method consistent with the embodiments of the present disclosure, the output method may be applied to the output apparatus mentioned above. The output method includes S801 to S803.

At S801, when the output apparatus is in the first mode, the first media data is obtained from the first processing apparatus and is output to the first output device, and the first processing apparatus is controlled to transmit the interaction data with the first interaction apparatus connected to the output apparatus.

The first processing apparatus may be connected to the output apparatus through the first interface group of the output apparatus.

It should be noted that, in the case where the output apparatus is connected to two processing apparatuses, one processing apparatus that is connected to the output apparatus and the interaction apparatus at any time as the first processing apparatus, and the mode in which the output apparatus is at the current time as the first mode. Correspondingly, the other mode that needs to be switched to after being in the first mode may be the second mode, and the processing apparatus that provides media data in the second mode is called the second processing apparatus.

At S802, based on the multifunctional interface, the output apparatus and the second output apparatus connected to the output apparatus are controlled to switch synchronously from the first mode to the second mode.

The multifunctional interface may be used to be connected to the second output apparatus. For example, as mentioned above, the multifunctional interface may be a thunderbolt interface or other interfaces that support the transmission of media data and interaction data.

When the second output apparatus is in the first mode, the second output apparatus may obtain the second media data from the first processing apparatus and output it to the second output device of the second output apparatus.

In the first mode, the output apparatus may also obtain the second media data from the first processing apparatus and transmit the second media data to the second output apparatus through the multifunctional interface for connecting the second output apparatus.

There are other possibilities for the specific implementation of the second output apparatus obtaining the second media data. For details, references may be made to previous description, which will not be repeated here.

The output apparatus may perform the operation at S802 when it is determined that the condition for switching from the first mode to the second mode is satisfied. For the specific implementation of determining that the condition of switching from the first mode to the second mode is satisfied, references may be made to the previous related description, which will not be repeated here.

The output apparatus may control itself and the second output apparatus to synchronously switch from the first mode to the second mode by that: the output apparatus switches from the first mode to the second mode, and the output apparatus sends the mode switching signal to the second output apparatus, where the mode switching signal is used to indicate switching from the first mode to the second mode.

At S803, when the output apparatus is in the second mode, the third media data from the second processing apparatus is obtained and output to the first output device, and the second processing apparatus is controlled to transmit the interaction data with the first interaction apparatus.

When the second output apparatus is in the second mode, the second output apparatus may obtain the fourth media data from the second processing apparatus and output it to the second output device.

In the second mode, the output apparatus may also obtain the fourth media data from the second processing apparatus, and transmit the fourth media data to the second output apparatus through the multifunctional interface for connecting the second output apparatus.

In some other embodiments, the second output apparatus may also directly obtain the fourth media data from the second processing apparatus, and the references may be made to the previous description for details, which will not be repeated here.

As can be seen from the embodiment of FIG. 8, the output apparatus may control the output apparatus and the second output apparatus connected thereto to synchronously switch between the first mode and the second mode, such that the two output apparatuses are able to be synchronously switched to the same media data source. Also, the interaction apparatus connected to the output apparatus may also be synchronously controlled to be connected to the processing apparatus corresponding to the media data source, such that the switching between the processing apparatuses connected to different types of interfaces of the output apparatus may be controlled while the two output apparatuses are synchronously switching the media data source, thereby reducing the complexity of apparatus switching.

Combined with the above description, there may be multiple possible situations for the second interface group connected to the second processing apparatus on the output apparatus. When the number and type of interfaces included in the second interface group are different, the specific implementation method of controlling the transmission of interaction data between the second processing apparatus and the first interaction apparatus may also be different.

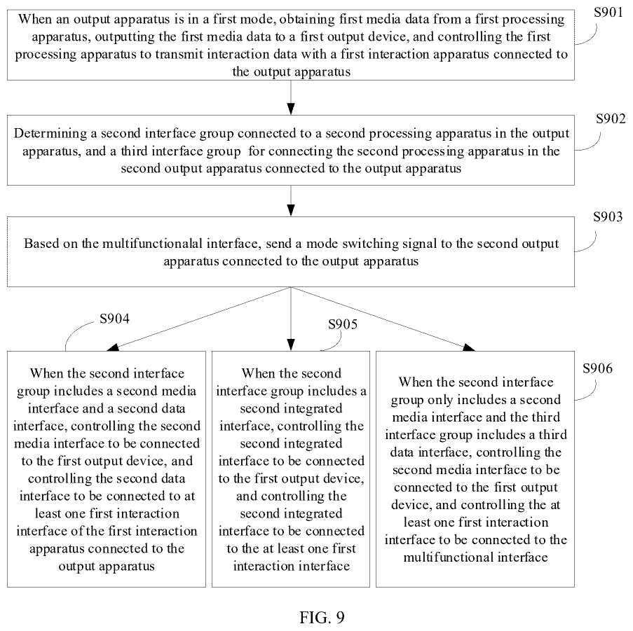

In another embodiment, as shown in FIG. 9, which is a flowchart of another output method, the method of this embodiment may be applied to the output apparatus. The method includes S901 to S906.

At S901, when the output apparatus is in the first mode, the first media data from the first processing apparatus is obtained and output to the first output device, and the first processing apparatus is controlled to transmit the interaction data with the first interaction apparatus connected to the output apparatus.

At S902, the second interface group, of the output apparatus, that is connected to the second processing apparatus, and the third interface group, of the second output apparatus connected to the output apparatus, for connecting to the second processing apparatus are determined.

Determining the second interface group may include determining the specific composition of the second interface group used to be connected to the second processing apparatus. For example, it may include determining the interface connection information of the second interface group, and the interface connection information may include whether the second interface group is connected to the processing apparatus, and what types of interfaces the second interface group connected to the second processing apparatus use. By determining the second interface group connected to the second processing apparatus, it may be determined whether the output apparatus is connected to the second processing apparatus through a comprehensive interface, a media interface and a data interface, or only through a media interface.

Similarly, determining the third interface group may include determining the specific composition of the third interface group of the second output apparatus connected to the second processing apparatus, such as determining the interface connection information of the third interface group. Accordingly, by determining the third interface group of the second output apparatus connected to the second processing apparatus, what types of interfaces the second output apparatus is connected to the second processing device may be determined.

The specific implementation of the output apparatus determining the third interface group may be multiple, and, for the detailed, references may be made to the previous related description, which will not be repeated.

It can be understood that S902 may be executed under the mode switching condition, such as when the condition of switching from the first mode to the second mode is met, or it can be executed at any time, or it can be executed when it is detected that the output apparatus is connected to the second processing apparatus, without limitation.

S903, based on the multifunctional interface, the mode switching signal is sent to the second output apparatus connected to the output apparatus.

The mode switching signal may be used to indicate that the second output apparatus switches from the first mode to the second mode.

S904, if the second interface group includes the second media interface and the second data interface, the second media interface is controlled to be connected to the first output device, and the second data interface is controlled to be connected to at least one first interaction interface connected to the first interaction apparatus of the output apparatus.

A least one first interaction interface may be used to be connected to the first interaction apparatus.

At S905, if the second interface group includes a second integrated interface, the second integrated interface is controlled to be connected to the first output device, and the second integrated interface is controlled to be connected to at least one first interaction interface.

It can be understood that, in the case where the second interface group supports the transmission of media data and interaction data, the present disclosure may realize the connection between the first interaction apparatus connected to the at least one first interaction interface and the second processing apparatus connected to the second interface group by controlling the second data interface or the second integrated interface in the second interface group to be connected to at least one first interaction interface of the output apparatus, such that the first interaction apparatus may transmit interaction data with the second processing apparatus.

For the above two steps, references may be made to the relevant description in the previous output apparatus embodiment, which will not be repeated here.

At S906, if the second interface group only includes the second media interface and the third interface group includes the third data interface, the second media interface is controlled to be connected to the first output device, and at least one first interaction interface is controlled to be connected to the multifunctional interface, such that the first interaction apparatus may transmit interaction data with the second processing apparatus through the multifunctional interface and the third data interface.

It can be understood that if the second interface group only includes the second media interface, the output apparatus cannot connect the first interaction apparatus with the second processing apparatus by connecting the second interface group with at least one first interaction interface. When the third interface group connected to the second output apparatus and the second processing apparatus includes the third data interface, it may mean that the second output apparatus has the possibility of transmitting interaction data with the second processing apparatus.

Therefore, since the second output apparatus will also switch to the second mode synchronously after receiving the mode switching signal, the second output apparatus may connect the third data interface with the multifunctional interface connected to the output apparatus, such that the third data interface is connected to the multifunctional interface of the output apparatus. Therefore, by controlling the first interaction interface to connect to the multifunctional interface of the output apparatus, the connection between the first interaction interface, the multifunctional interface and the third data interface may be achieved, and naturally the first processing apparatus and the first interaction apparatus may transmit media data.

It can be understood that by executing the above S904, S905 or S906, the output apparatus may be switched from the first mode to the second mode.

It can be understood that in the above embodiments of the present disclosure, the output apparatus may also control the output apparatus and the second output apparatus to switch synchronously from the first mode to the third mode based on the multifunctional interface. For example, after confirming that the condition for switching from the first mode to the third mode is met, the output apparatus may be controlled to switch from the first mode to the third mode, and a second mode switching signal may be sent to the second output apparatus, where the second mode switching signal is used to indicate the switch from the first mode to the third mode.

Correspondingly, when the output apparatus is in the third mode, the output apparatus may obtain the fifth media data from the third processing apparatus and output it to the first output device, and control the first processing apparatus and the first interaction apparatus to transmit interaction data.

When the second output apparatus is in the third mode, the second output apparatus may obtain the sixth media data from the third processing apparatus and output it to the second output device.

For the output apparatus in the third mode, references may be made to the relevant description of the previous output apparatus embodiments, which will not be repeated here.

Further, before controlling the output apparatus and the second output apparatus to switch synchronously from the first mode to the third mode, the output apparatus may also determine the fourth interface group in the second output apparatus for connecting the third processing apparatus. For example, after detecting the switching instruction from the first mode to the third mode, the fourth interface group may be determined.

Accordingly, when the fourth interface group does not include the fourth data interface, based on the multifunctional interface, the output apparatus and the second output apparatus may be controlled to switch from the first mode to the third mode synchronously.

When the fourth interface group includes the fourth data interface, the output apparatus and the second output apparatus may be controlled to switch from the first mode to the fourth mode synchronously.

Accordingly, when the output apparatus is in the fourth mode, the fifth media data from the third processing apparatus may be obtained, and the second interaction apparatus may be controlled to transmit interaction data with the third processing apparatus through the multifunctional interface and the fourth data interface.

The present disclosure also provides a computer-readable storage medium. The computer-readable storage medium may be configured to store at least one instruction, at least one program, a code set, or an instruction set. The at least one instruction, the at least one program, the code set or the instruction set may be loaded and executed by a processor to implement the output method provided by any one of the above embodiments of the present disclosure.

The present disclosure also provides a computer program, which includes computer instructions. The computer instructions may be stored in a computer-readable storage medium. When the computer program is run on an electronic device, it may be configured to execute the output method provided by any one of the above embodiments of the present disclosure.

In the present disclosure, the terms such as “first,” “second,” “third,” “fourth,” etc. (if any) in the specification and claims and the above-mentioned drawings are used to distinguish similar parts, and are not necessarily used to describe a specific order or sequence. It should be understood that the data used in this way can be interchanged where appropriate, such that the embodiments of the present disclosure described here can be implemented in an order other than that illustrated here.

Various embodiments in this specification are described in a progressive manner, and each embodiment focuses on the differences from other embodiments, and the same and similar parts between the various embodiments can be referred to each other. At the same time, the features recorded in the various embodiments in this specification can be replaced or combined with each other, such that those skilled in the art can implement or use the present disclosure. For the device embodiment, since it is basically similar to the method embodiment, the description is relatively simple, and the relevant parts can be referred to the partial description of the method embodiment.

In the present disclosure, relational terms such as first and second, etc. are only used to distinguish one entity or operation from another entity or operation, and do not necessarily require or imply any such actual relationship or order between these entities or operations. Moreover, the terms “includes,” “comprise,” “including,” or any other variants thereof are intended to cover non-exclusive inclusion, such that a process, method, article or device comprising a series of elements includes not only those elements, but also other elements not explicitly listed, or also includes elements inherent to such process, method, article or device. In the absence of further restrictions, an element defined by the sentence “including a” does not exclude the presence of other identical elements in the process, method, article or device comprising the element.

The above description of the disclosed embodiments enables those skilled in the art to implement or use the present disclosure. Various modifications to these embodiments will be obvious to those skilled in the art, and the general principles defined herein can be implemented in other embodiments without departing from the spirit or scope of the present disclosure. Therefore, the present disclosure is not limited to the embodiments shown herein, but will conform to the widest scope consistent with the principles and novel features disclosed herein.

The above are only preferred embodiments of the present disclosure. It should be noted that for those of ordinary skill in the art, several improvements and modifications can be made without departing from the principles of the present disclosure, and these improvements and modifications should also be regarded as the scope of protection of the present disclosure.

What is claimed is:

1. An output apparatus comprising:
an interaction interface;
a first interface group;
a second interface group;
a multifunctional interface;
a first output device; and
a processing device configured to control, through the multifunctional interface, the output apparatus and another output apparatus connected to the multifunctional interface to synchronously switch from a first mode to a second mode;
wherein:
when the output apparatus is in the first mode:
the first output device is able to output first media data from a first processing apparatus connected to the first interface group;
a second output device of the other output apparatus is able to output second media data from the first processing apparatus; and
the first processing apparatus and an interaction apparatus connected to the interaction interface are able to transmit interaction data with each other; and
when the output apparatus is in the second mode:
the first output device is able to output third media data from a second processing apparatus connected to the second interface group;
the second output device is able to output fourth media data from the second processing apparatus; and
the second processing apparatus and the interaction apparatus are able to transmit interaction data with each other.

2. The output apparatus according to claim 1, wherein:
the interaction interface is a first interaction interface and the interaction apparatus is a first interaction apparatus;
the second output apparatus includes a second interaction interface;
when the output apparatus is in the first mode, the first processing apparatus is able to transmit interaction data with a second interaction apparatus connected to the second interaction interface through the multifunctional interface; and
when the output apparatus is in the second mode, the second processing apparatus is able to transmit interaction data with the second interaction apparatus through the multifunctional interface.

3. The output apparatus according to claim 2, wherein:
the first interface group includes:
a first data interface supporting interaction data transmission and a first media interface supporting media data transmission; or
a first integrated interface supporting interaction data and media data transmission;
the second interface group includes:
a second data interface supporting interaction data transmission and a second media interface supporting media data transmission; or
a second integrated interface supporting interaction data and media data transmission;
the processing device is further configured to:
when the output apparatus is in the first mode, control the first media interface or the first integrated interface to be connected to the first output device, and control the first data interface or the first integrated interface to be connected to the first interaction interface and the multifunctional interface; and
when the output apparatus is in the second mode, control the second media interface or the second integrated interface to be connected to the first output device, and control the second data interface or the second integrated interface to be connected to the first interaction interface and the multifunctional interface.

4. The output apparatus according to claim 1, wherein:
the first interface group includes:
a first data interface supporting interaction data transmission and a first media interface supporting media data transmission; or
an integrated interface supporting interaction data and media data transmission;
the second interface group includes a second media interface supporting media data transmission;
the other output apparatus includes a third interface group configured to be connected to the second processing apparatus, the third interface group including a second data interface supporting interaction data transmission and a third media interface supporting media data transmission; and
the processing device is further configured to:
determine, through the multifunctional interface, that the third interface group includes the second data interface; and
when the output apparatus is in the second mode, control the second media interface to be connected to the first output device, and control the interaction interface and the multifunctional interface to be connected to each other, to enable the interaction apparatus to transmit interaction data with the second processing apparatus through the multifunctional interface and the second data interface.

5. The output apparatus according to claim 1, further comprising:
an independent media interface;
wherein:
the processing device is further configured to control the output apparatus and the other output apparatus to synchronously switch from the first mode to a third mode, or from the third mode to the first mode, based on the multifunctional interface; and
when the output apparatus is in the third mode:
the first output device is able to output fifth media data from a third processing apparatus connected to the independent media interface;
the second output device is able to output sixth media data from the third processing apparatus; and
the first processing apparatus and the interaction apparatus are able to transmit interaction data with each other.

6. The output apparatus according to claim 5, wherein:
the second output apparatus further includes a data interface configured to be connected to the third processing apparatus;
the processing device is further configured to control the output apparatus and the other output apparatus to switch from the first mode to a fourth mode synchronously, or from the fourth mode to the first mode, based on the multifunctional interface; and
when the output apparatus is in the fourth mode:
the first output device is able to output the fifth media data from the third processing apparatus;
the second output device is able to output the sixth media data from the third processing apparatus; and
the interaction apparatus is able to transmit interaction data with the third processing apparatus through the multifunctional interface and the data interface.

7. An output method comprising:
when a first output apparatus is in a first mode, obtaining first media data from a first processing apparatus, outputting the first media data to a first output device, and controlling the first processing apparatus to transmit interaction data with an interaction apparatus connected to the first output apparatus;
based on a multifunctional interface, of the first output apparatus, that is connected to a second output apparatus, controlling the first output apparatus and the second output apparatus to switch synchronously from the first mode to a second mode, the second output apparatus being configured to, when in the first mode, obtain second media data from the first processing apparatus and output the second media data to a second output device of the second output apparatus; and
when the first output apparatus is in the second mode, obtaining third media data from a second processing apparatus, outputting the third media data to the first output device, and controlling the second processing apparatus to transmit interaction data with the interaction apparatus;
wherein the second output apparatus is further configured to, when in the second mode, obtain fourth media data from the second processing apparatus and output the fourth media data to the second output device.

8. The output method according to claim 7, wherein controlling the first output apparatus and the second output apparatus to switch synchronously from the first mode to the second mode includes:
sending a mode switching signal to the second output apparatus to instruct the second output apparatus to switch from the first mode to the second mode.

9. The output method according to claim 7, further comprising, before controlling the first output apparatus and the second output apparatus to switch synchronously from the first mode to the second mode:
determining an interface group, of the first output apparatus, that is connected to the second processing apparatus and an interface group, of the second output apparatus, for connecting to the second processing apparatus.

10. The output method according to claim 7,
wherein the interface group of the first output apparatus includes a media interface and a data interface;
the method further comprising:
controlling the media interface to be connected to the first output device; and
controlling the data interface to be connected to an interaction interface, of the first output apparatus, that is connected to the interaction apparatus.

11. The output method according to claim 7,
wherein the interface group of the first output apparatus includes an integrated interface;
the method further comprising:
controlling the integrated interface to be connected to the first output device; and
controlling the integrated interface to be connected to an interaction interface, of the first output apparatus, that is connected to the interaction apparatus.

12. The output method according to claim 7,
wherein the interface group of the first output apparatus only includes a media interface and the interface group of the second output apparatus includes a data interface;
the method further comprising;
controlling the media interface to be connected to the first output device, and controlling an interaction interface, of the first output apparatus, that is connected to the interaction apparatus, to be connected to the multifunctional interface, to enable the interaction apparatus to transmit interaction data with the second processing apparatus through the multifunctional interface and the data interface.

13. The output method according to claim 7, further comprising:
based on the multifunctional interface, controlling the first output apparatus and the second output apparatus to switch synchronously from the first mode to a third mode; and
when the first output apparatus is in the third mode, obtaining fifth media data from a third processing apparatus, outputting the fifth media data to the first output device, and controlling the first processing apparatus and the interaction apparatus to transmit interaction data;
wherein when the second output apparatus is in the third mode, the second output apparatus is able to obtain sixth media data from the third processing apparatus and output the sixth media data to the second output device.

14. The output method according to claim 13,
wherein the interaction apparatus is a first interaction apparatus;
the method further comprising, before controlling the first output apparatus and the second output apparatus to switch synchronously from the first mode to the third mode:
determining an interface group of the second output apparatus for connecting to the third processing apparatus;
in response to the interface group including a data interface, controlling the first output apparatus and the second output apparatus to switch synchronously from the first mode to a fourth mode; and
when the first output apparatus is in the fourth mode, obtaining the fifth media data from the third processing apparatus, and controlling a second interaction apparatus connected to the second output apparatus to transmit interaction data with the third processing apparatus through the multifunctional interface and the data interface.

15. The output method according to claim 14, wherein controlling the first output apparatus and the second output apparatus to switch synchronously from the first mode to the third mode includes:
controlling the first output apparatus and the second output apparatus to switch synchronously from the first mode to the third mode in response to the interface group not including the data interface.
